(19) United States
(12) Patent Application Publication
(10) Pub. No.: US 2014/0297345 A1
(43) Pub. Date: Oct. 2, 2014

(54) USING CUSTOMER PREFERENCES TO MINIMIZE IMPACT OF REQUIRED MAINTENANCE

(71) Applicant: John Alan Gervais, Princeton, NJ (US)

(72) Inventor: John Alan Gervais, Princeton, NJ (US)

(73) Assignee: THOMSON LICENSING a corporation

(21) Appl. No.: 14/355,275

(22) PCT Filed: Dec. 2, 2011
(86) PCT No.: PCT/US2011/063107

§ 371 Date: Apr. 30, 2014

(51) Int. Cl. G06Q 10/06

(52) U.S. Cl. CPC G06Q 10/06311
USPC 705/7.13

(57) ABSTRACT

A method for scheduling system maintenance in consumer premises equipment is described including accepting customer preferences correlation with content and maintenance information, determining a present time, determining a duration of the system maintenance, calculating an ending time of the system maintenance, determining if the ending time of the system maintenance interferes with the customer preferences correlation, if the ending time of the system maintenance will not interfere with the customer preferences correlation, then determining if a customer is currently accessing preferred content or current content is strongly correlated with the customer preferences or if access to preferred content is anticipated before the ending time of the system maintenance and scheduling the system maintenance responsive to the third and fourth determining steps.

### FIELD OF THE INVENTION

The present invention relates to scheduling of system maintenance of consumer devices so as to minimize the impact of the required system maintenance by considering customer's viewing habits and preferences.

### BACKGROUND OF THE INVENTION

In multicast and broadcast applications, data are transmitted from a server to multiple receivers over wired and/or wireless networks. A multicast system as used herein is a system in which a server transmits the same data to multiple receivers simultaneously, where the receivers form a subset of all the receivers up to and including all of the receivers. A broadcast system is a system in which a server transmits the same data to all of the receivers simultaneously. That is, a multicast system by definition can include a broadcast system.

Consumer electronics devices periodically require maintenance, which cannot be supported during normal user operation. Servicing these needs can block normal customer usage and irritate the customer. These same devices frequently use various techniques to determine or predict customer content preferences based on manual settings, past viewing habits, etc. This information is frequently used for suggested content or sales offers. By using this information to better predict when the customer is not using the system or not strongly interested in the content being displayed (rendered) then maintenance can be postponed until the predicted times. Thus, customer irritation can be reduced.

### SUMMARY OF THE INVENTION

The present invention uses a customer's viewing habits, preferred content genre and other preferences to better predict when he/she is not using the system or not strongly interested in its content to limit the intrusion of required system maintenance, power optimization, etc. While the present invention is described in terms of a device that is used for viewing content, it is not so limited and may be used for related devices such as digital video recorders (DVRs), personal video recorders (PVRs), etc which may also require maintenance.

A method for scheduling system maintenance in consumer premises equipment is described including accepting customer preferences correlation with content and maintenance information, determining a present time, determining a duration of the system maintenance, calculating an ending time of the system maintenance, determining if the ending time of the system maintenance interferes with the customer preferences correlation, if the ending time of the system maintenance will not interfere with the customer preferences correlation, then determining if a customer is currently accessing preferred content or current content is strongly correlated with the customer preferences or if access to preferred content is anticipated before the ending time of the system maintenance and scheduling the system maintenance responsive to the third and fourth determining steps.

### BRIEF DESCRIPTION OF THE DRAWINGS

The present invention is best understood from the following detailed description when read in conjunction with the accompanying drawings. The drawings include the following figures briefly described below:

FIG. 1 is a schematic diagram of the present invention.

FIGS. 2A and 2B together are a flowchart of an exemplary embodiment of the maintenance scheduling method of the present invention.

FIG. 3 is a block diagram of an exemplary embodiment of the present invention in a customer (consumer) end device.

### DETAILED DESCRIPTION OF THE PREFERRED EMBODIMENTS

This issue has been mitigated in the past by pop-up message windows asking the customer for permission to perform the required maintenance. These pop-ups during broadcasts of content, as well as the maintenance itself, can irritate the customer. If possible, the maintenance is postponed until early morning hours when viewing is less likely to occur. Also, maintenance may be postponed, if possible, until the device is placed in a standby mode indicating the customer is not using it. These methods may be used in conjunction with this invention where applicable.

Consumer electronics devices periodically require maintenance, which cannot be supported during normal user operation. Servicing these needs can block normal customer usage and irritate the customer. Pop-ups to request permission can irritate the customer as well. These same devices frequently use various techniques to determine or predict customer content preferences based on manual settings, past viewing habits, etc. This information is used to suggest content or for sales offers. By postponing maintenance needs when the customer is accessing highly preferred content, the risk of irritating the customer can be lessened. The content being accessed in this case does not need to be pay-per-view or similar specifically requested content by the customer. It could be as simple as the channel on which the device was left. If the current content correlates strongly with customer preferences, the device could avoid prompting for maintenance until the content changes to something less correlated.

Some examples of maintenance would be execution of a software upgrade or moving to a low power standby mode as a requirement of Energy Star or similar governmental specifications. In these cases a simple deferment of the action would lessen the probability of irritating the customer. Conversely if these actions were taken during a program or content less preferred by the customer, it is more likely the customer would accept the required maintenance graciously, and thereby increasing support of required maintenance. The algorithm could be as simple as deferring maintenance operations during programs of high correlation with the customer's preferences or past viewing habits. Or it could be more complex in which the deferment time were a function of the level to which the customer preferences correlated with the current and perhaps future content on the current channel or similar stream of content.

An example would be postponing prompting for permission to do a software upgrade until after a football game on TV is over if the customer has a significant history including watching football or otherwise has indicated a preference for football content.

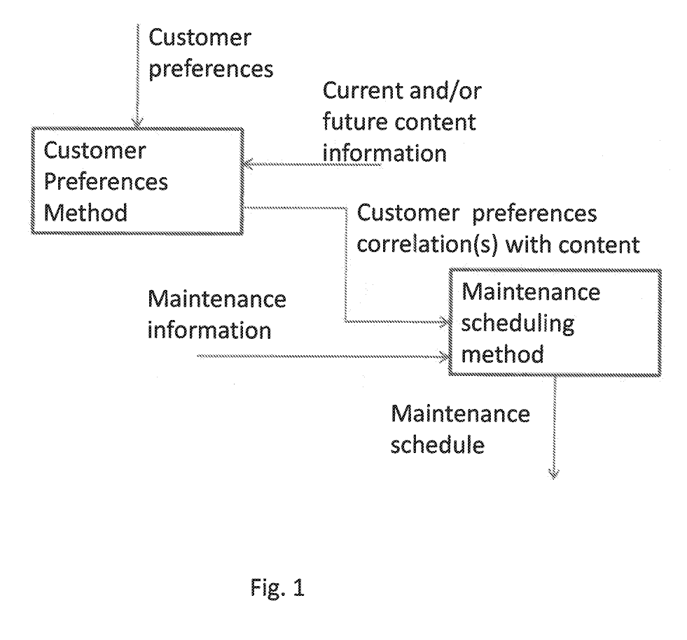

FIG. 1 is a schematic diagram of the present invention. The customer preferences and current and/or future content information are input to one of a plurality of customer preferences methods. Customer preferences correlation(s) with content are output from the customer preferences method and accepted by (received by) the maintenance scheduling method of the present invention. The maintenance scheduling method also receives information about the maintenance to be scheduled such as the type (software upgrade or update, preventative maintenance including tests, etc.), expected duration, etc.

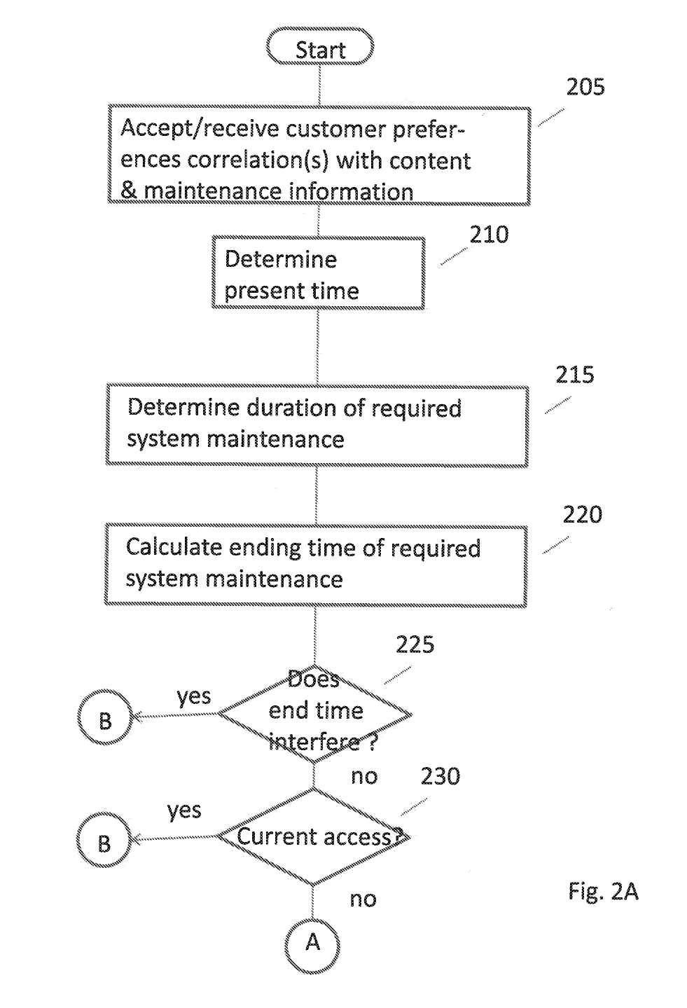

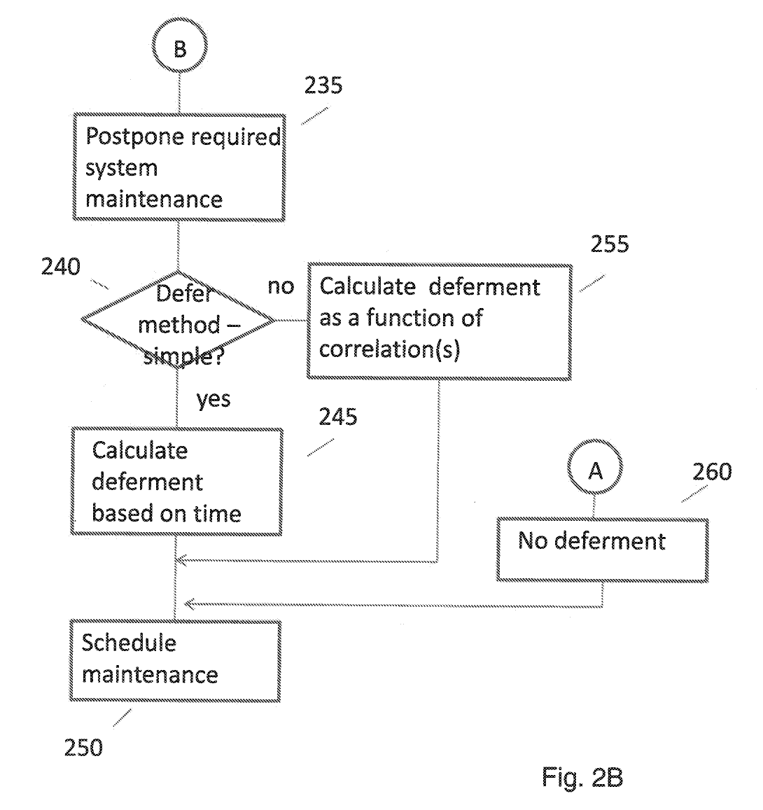

FIGS. 2A and 2B together are a flowchart of an exemplary embodiment of the maintenance scheduling method of the present invention. Customer preferences correlation(s) with content are output from the customer preferences method and accepted by (received by) the maintenance scheduling method of the present invention. At 205 the maintenance scheduling method of the present invention receives/(accepts) the customer preferences correlation(s) with content and maintenance information. The maintenance scheduling method of the present invention has access to a clock (system) in the end device. Using the clock at 210 the maintenance scheduling method determines the present time. Using the maintenance information, at 215 the maintenance scheduling method determines the expected (anticipated) duration of the required system maintenance. Using the present time and the expected duration of the required system maintenance, at 220 the maintenance scheduling method determines (calculates) the ending time of the required system maintenance. At 225 a test is performed to determine if the determined ending time interferes with the correlation of the customer preferences. If the ending time does not interfere then at 230 a test is performed to determine if the customer is currently accessing preferred content or current content is strongly correlated with the customer preferences. In this case ‘currently accessing preferred content’ may also include anticipated access of preferred content such as when the currently access content may not be preferred but the content that is following the currently accessed content is preferred content and falls into the time interval of expected system maintenance duration. If the customer is not currently accessing preferred content or current content is not strongly correlated with the customer preferences then at 260, there is no deferment and the required system maintenance is immediately scheduled at 250. If customer is currently accessing preferred content or current content is strongly correlated with the customer preferences then at 235 the required system maintenance is postponed. At 240 a test is performed to determine if the determination of deferment is to be simple. If the deferment method is simple then at 245 the deferment is calculated (determined) based on time using the clock (system). If the deferment is not to be simple but more complex, then at 255 the deferment is determined (calculated) as a function of the customer preferences correlation(s). In either case of postponement, the required system maintenance is scheduled at 250 using the deferment, if any. If the ending time interferes with the correlation of the customer preferences then processing proceeds to 235 (already described above).

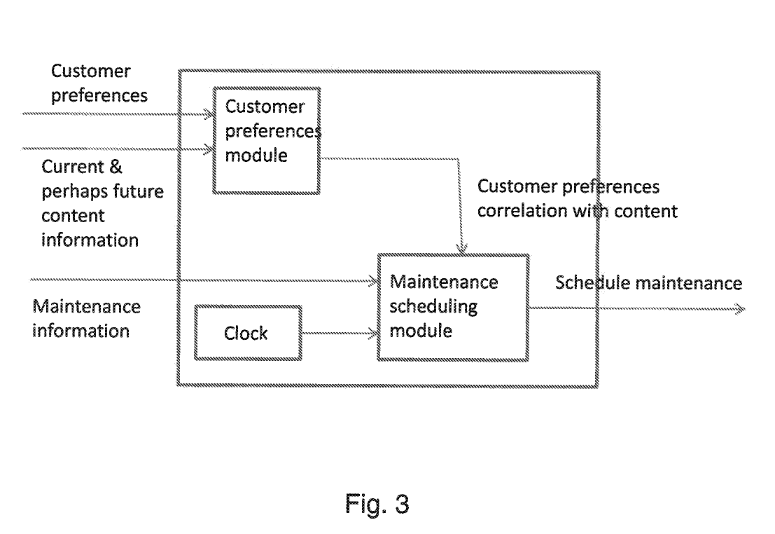

FIG. 3 is a block diagram of an exemplary embodiment of the present invention in a customer (consumer) end device, where a consumer (customer) end device may be consumer premises equipment such as a TV, a DVR, a PVR, a set top box (STB) or any equivalent device. In the end device shown in FIG. 3 there is a customer preferences module, which receives (accepts) customer preferences and content information (current content information and perhaps future content information) and correlates the content and the customer preferences and outputs the customer preferences correlation(s) with content to the maintenance scheduling module. The maintenance scheduling module receives (accepts) the customer preferences correlation(s) with content and has access to a clock (system) of the end device. Using the clock and the customer preferences correlation(s) with content, the maintenance scheduling module determines a maintenance schedule for the required system maintenance.

It is to be understood that the present invention may be implemented in various forms of hardware, software, firmware, special purpose processors, or a combination thereof. Preferably, the present invention is implemented as a combination of hardware and software. Moreover, the software is preferably implemented as an application program tangibly embodied on a program storage device. The application program may be uploaded to, and executed by, a machine comprising any suitable architecture. Preferably, the machine is implemented on a computer platform having hardware such as one or more central processing units (CPU), a random access memory (RAM), and input/output (I/O) interface(s). The computer platform also includes an operating system and microinstruction code. The various processes and functions described herein may either be part of the microinstruction code or part of the application program (or a combination thereof), which is executed via the operating system. In addition, various other peripheral devices may be connected to the computer platform such as an additional data storage device and a printing device.

It is to be further understood that, because some of the constituent system components and method steps depicted in the accompanying figures are preferably implemented in software, the actual connections between the system components (or the process steps) may differ depending upon the manner in which the present invention is programmed. Given the teachings herein, one of ordinary skill in the related art will be able to contemplate these and similar implementations or configurations of the present invention.

1. A method for scheduling system maintenance in consumer premises equipment, said method comprising:
accepting customer preferences correlation with content and maintenance information from a customer preferences module in said customer premises equipment;
determining a present time;
determining a duration of the system maintenance;
calculating an ending time of the system maintenance;
determining if the ending time of the system maintenance interferes with the customer preferences correlation;
if the ending time of the system maintenance will not interfere with the customer preferences correlation, then determining if a customer is currently accessing preferred content or current content is strongly correlated with the customer preferences or if access to preferred content is anticipated before the ending time of the system maintenance; and
scheduling the system maintenance responsive to the third and fourth determining steps.

2. The method according to claim 1, further comprising postponing the scheduling step responsive to the third and fourth determining steps.

3. The method according to claim 2, further comprising determining a deferment method.

4. The method according to claim 3, wherein the deferment method is based on time.

5. The method according to claim 3, wherein the deferment method is a function of the customer preferences correlation.

6. The method according to claim 1, wherein customer premises equipment includes equipment for rendering content.

7. A customer end device, comprising:
a customer preferences module, said customer preferences module being capable of accepting customer preferences and content information and correlating the content information and the customer preferences and communicating results of the correlation operation to a maintenance scheduling module;
said maintenance scheduling module in communication with the customer preferences module; and
a clock, the clock in communication with the maintenance scheduling module.

8. (canceled)

9. The maintenance scheduling module of the customer end device according to claim 8, being capable of accepting the results of the correlation operation from the customer preferences module and accessing the clock and determining a maintenance schedule responsive to the results of the correlation operation and the clock.

10. The maintenance scheduling module according to claim 9, wherein the scheduling is postponed if the ending time of the system maintenance interferes with the customer preferences correlation or if a customer is currently accessing preferred content or current content is strongly correlated with the customer preferences or if access to preferred content is anticipated before the ending time of the system maintenance.

11. The maintenance scheduling module according to claim 10, further comprising determining a deferment method if system maintenance scheduling is postponed.

12. The maintenance scheduling module according to claim 11, wherein the deferment method is based on time.

13. The maintenance scheduling module according to claim 12, wherein the deferment method is a function of the customer preferences correlation.

14. The customer end device according to claim 7, wherein customer premises equipment includes equipment for rendering content.
